(19) United States
(12) Patent Application Publication
(10) Pub. No.: US 2022/0332000 A1
(43) Pub. Date: Oct. 20, 2022

(54) CONSUMER PRODUCT PACKAGE

(71) Applicant: The Gillette Company LLC, Boston, MA (US)

(72) Inventors: Merrie Paulette Foster, Boston, MA (US); Andrew Martin Joseph Gauvin, Rochester, NY (US)

(21) Appl. No.: 17/235,465

(22) Filed: Apr. 20, 2021

(51) Int. Cl. B26B 21/40; B65D 85/62; B65D 17/28

(52) U.S. Cl. CPC B26B 21/4012; B65D 85/62; B65D 17/4012; B65D 2501/24878

(57) ABSTRACT

A consumer product package with a first outer panel having a first end with a first adhesive region and a first fold line, a second outer panel, an inner panel positioned between the first outer panel and the second outer panel. The inner panel is configured to receive a first consumer product. A product return envelope extends from the second outer panel with a perforated joint between the product return envelope and the second outer panel. The product return envelope defines a pocket. An adhesive strip is positioned between the perforated joint and the pocket. A tear tab is positioned between the first adhesive region and the first fold line of the first outer panel.

### FIELD OF THE INVENTION

The present invention relates to packages for consumer products and more particularly, to direct to consumer packages that enable product to be returned or delivered to a third party.

### BACKGROUND OF THE INVENTION

More consumers are starting to prefer shopping online and receiving product in the mail rather than going to stores to make purchases in person. Accordingly, manufactures have been providing direct to consumer (DTC) packages to ship their products safely and economically to consumers. Another consumer trend is sustainability. Consumers prefer products and packages that are more sustainable and have less of an environmental impact. However, consumers often do not understand how to recycle their razors and or razor cartridges. Currently there is no standardized recycling stream for consumer products, such as shaving razors. For example, consumers would need to collect their used shaving razors and cartridges and bring them to a store with a sponsored recycling collection system. As of today, there are very view stores that offer recycling collection systems for consumer products, such as razors. Furthermore, if consumers prefer to do their shopping online, they most likely do not want to have to go to a store to recycle their products. Consumers are less likely to recycle if it is too burdensome or complicated. Accordingly, rather than recycle their shaving razors and shaving cartridges, they end up throwing them in the trash.

More packages are being designed for direct to consumer product offerings. However, consumers would still need to leave their home to recycle these products. Despite the use of known packaging techniques, there remains a need to further modify consumer product packages to provide a package that allows a consumer to recycle their product when they are finished using it.

### SUMMARY OF THE INVENTION

In one aspect, the invention features, in general, a consumer product package with a first outer panel having a first end with a first adhesive region and a first fold line, a second outer panel, an inner panel positioned between the first outer panel and the second outer panel. The inner panel is configured to receive a first consumer product. A product return envelope extends from the second outer panel with a perforated joint between the product return envelope and the second outer panel. The product return envelope defines a pocket. An adhesive strip is positioned between the perforated joint and the pocket. A tear tab is positioned between the first adhesive region and the first fold line of the first outer panel.

In another aspect, the invention features, in general, a consumer product package with a first outer panel having a first end with a first adhesive region and a second end, a second outer panel and an inner panel positioned between the first outer panel and the second outer panel. A first consumer product is retained by the inner panel. A product return envelope is connected to the second outer panel at a perforated joint. The product return envelope defines a pocket dimensioned to receive the first consumer product. A second adhesive region is between the perforated joint and the pocket. A tear tab is between the first adhesive region and the second end of the first outer panel. The first adhesive region is sealed to the second outer panel in a closed position.

In another aspect, the invention features, in general, a method of recycling a consumer product. A consumer product package containing at least one consumer product is provided. The consumer product package is opened by removing a tear tab. A product return envelope having a recycler address label is removed from the consumer product package. The consumer product is inserted into a pocket of the product return envelope. The product return envelope is sealed. The product return envelope is mailed according to the recycler address label.

### BRIEF DESCRIPTION OF THE DRAWINGS

FIG. 1A is a front perspective view of one possible embodiment of consumer product package in a closed position

FIG. 1B is a front perspective view of the consumer product package of FIG. 1A in an open position.

FIG. 2A is a perspective view of the consumer product package of 1B holding a consumer product.

FIG. 2B is a perspective view of the consumer product package of FIG. 2A in a first folded position.

FIG. 2C is a perspective view of the consumer product package of FIG. 2A in a second folded position.

FIG. 3 is a perspective assembly view of the consumer product and product return envelope of the consumer product package of FIG. 2.

FIG. 4 is a perspective view of the product return envelope of FIG. 3 in a closed position.

FIG. 5 is a rear perspective view of the consumer product package in the closed position.

### DETAILED DESCRIPTION OF THE INVENTION

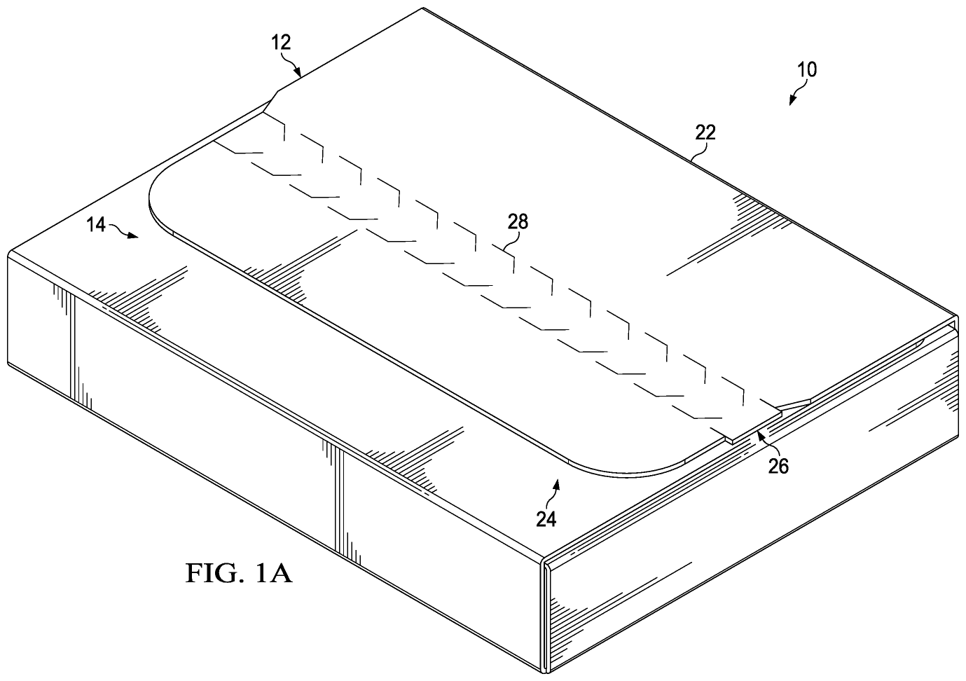

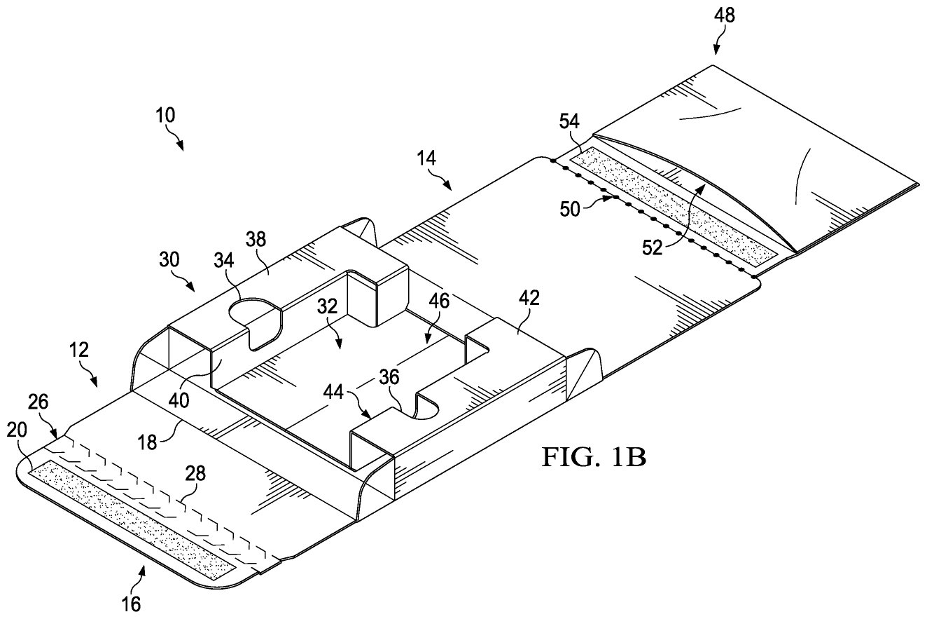

Referring to FIGS. 1A and 1B, one possible embodiment of the present invention is shown illustrating perspective views of a consumer product package 10 in a closed position and an opening position, respectively. The consumer product package 10 may be folded from a single sheet of formable material to create a box-like shape to contain one or more consumer products. The sheet of formable material may be die cut from a single sheet of material. The sheet of formable material may include one or more cellulose-based products such as cardboard, paperboard, paper sheet, bamboo and other sustainable, compostable, biodegradable or recycled/recyclable materials. The sheet of formable material may have one or more surfaces that are coated and/or have printed graphics. However, it is understood graphics may be applied at any step of the process. For example, labels may be applied to the consumer product package 10 in lieu of or in addition two graphics printed directly on the sheet. Current direct to consumer package designs contain multiple components, such as an outer box and a tray inserts to hold a consumer product. A single piece folded design may facilitate disposing of the box by the consumer (e.g., no parts to separate for different recycling streams).

The consumer product package 10 may have a first outer panel 12 and a second outer panel 14. The first outer panel 12 may have a first end 16 and first fold line 18. A first adhesive region 20 may be positioned between the first end 16 and the first fold line 18. The first fold line 18 may facilitate the forming of an edge 22 of the consumer product package 10 in the closed position, as shown in FIG. 1A. In the closed position, the first outer panel 12 may be folded over the second outer panel 14. The adhesive region 20 may secure the first outer panel 12 to an outer surface 24 (FIG. 1A) of the second outer panel 14. The first outer panel 12 may include a tear tab 26 between the first adhesive region 20 and the first fold line 18. The tear tab 26 may have a plurality of perforations 28 to facilitate the removal of the tear tab 26 and the easy opening of the consumer product package 10. The strength of the seal between the adhesive region 20 and the top surface 24 may be greater than the tear strength of the tear tab 26 to facilitate opening of the consumer product package 10. The tear tab 26 may provide a simple and intuitive way to open the consumer product package 10. For example, once the tear tab 26 is removed, the first outer panel 12 and the second outer panel 14 may simply unfold to reveal an inner panel 30 containing one or more consumer products (not shown).

Referring to FIG. 1B, the inner panel 30 may be positioned between the first outer panel 12 and the second outer panel 14 in the open position. As will be explained in greater detail below, the inner panel 30 may define a cavity 32 for retaining one or more consumer products (not shown). The inner panel 30 may define one or more openings 34 and 36 (e.g., a first opening 34 and a second opening 36) that also facilitate holding of one or more consumer products. The opening 34 may extend into a first top wall 38 and/or a first inner wall 40 of the inner panel 30. The opening 36 may extend into a second top wall 42 and/or a second inner wall 44 that opposes the first inner wall 40. The first inner wall 40 may extend from the first top wall 38 to a lower inner surface 46 of the inner panel 30. The second inner wall 44 may extend from the second top wall 42 to the lower inner surface 46 of the inner panel 30. In certain embodiments, the lower inner surface 46 may be substantially flat to receive and hold a consumer product (not shown). The lower inner surface 46 may be recessed relative to the first top wall 38 and the second top wall 42.

The second outer panel 14 may be positioned between the inner panel 30 and a product return envelope 48. The product return envelope 48 may extend from the second outer panel 14 with a perforated joint 50 between the product return envelope 48 and the second outer panel 14. The product return envelope 48 may define a pocket 52 configured to contain one or more consumer products to be recycled (not shown). An adhesive strip 54 may be positioned between the perforated joint 50 and the pocket 52. The adhesive strip 54 may include an upper layer that is removed to reveal an adhesive to facilitate the sealing of the product return envelope 48. The the first outer panel 12, the second outer panel 14, the product return envelope 48 and the inner panel 30 may be formed from a unitary sheet of formable material. The adhesive strip 54 and the first adhesive region 20 may be applied to the unitary sheet of formable material either before or after folding it into the consumer product package 10 illustrated in FIG. 1B. The folding of the consumer product package 10 from a single sheet of formable material may help reduce costs and complexity.

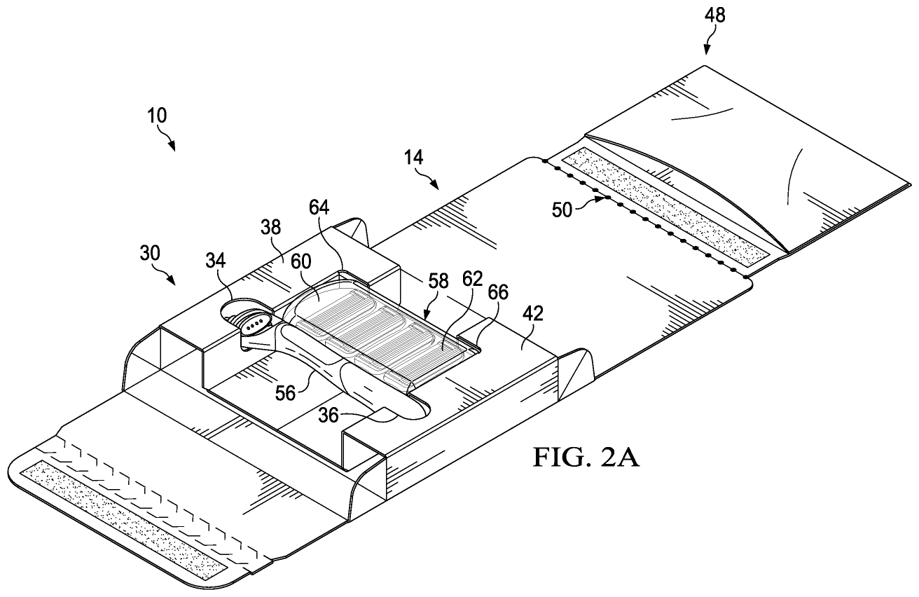

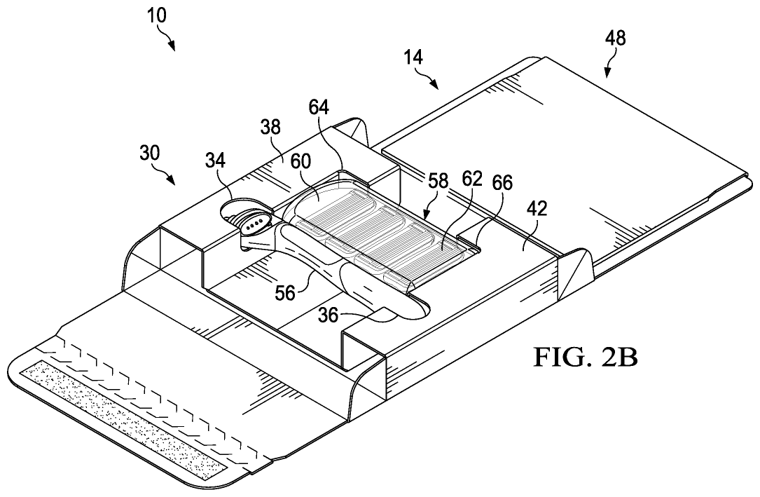

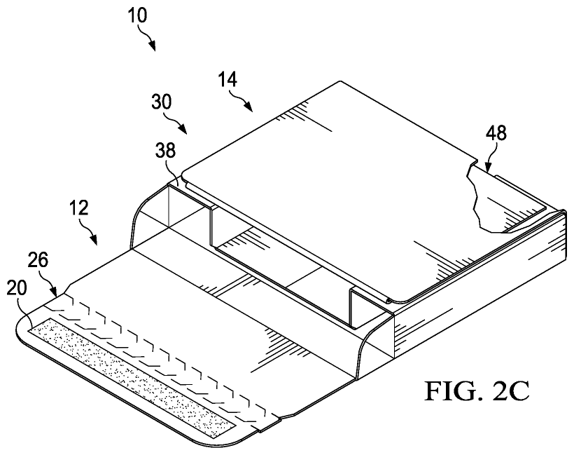

Referring to FIG. 2A, a perspective view the consumer product package 10 is illustrated in the open position holding one or more consumer products 56 and 58. The consumer products 56 and 58 may be at least partially retained by the inner panel 30. The consumer product 56 may be a handle and the consumer product 58 may include a dispenser 60 containing one or more cartridges 62. One or more of the consumer products 56 and 58 may be positioned between the first inner wall 40 and the second inner wall 44 (FIG. 1B). For example, the consumer product 58 may be positioned within the openings 34 and 36. The consumer product 58 may be positioned between the consumer product 56 and one or more side walls 64 and 66. In certain embodiments, the side walls 64 and 66 may be spaced apart to allow for easy access of the consumer product 60 once the consumer product package 10 is in the open position (i.e., the inner surface 46 may be open from one or more sides in the open position).

Referring to FIGS. 2B and 2C, a perspective view of the consumer product package of FIG. 2A in a first folded position and a second folded position, respectively. Once the consumer products 56, 58, 60 are positioned within the inner panel 30, the product return envelope 48 may be folded over the second outer panel 14, as shown in FIG. 2B, resulting in a first folded position. The product return envelope 48 may be folded along the perforated joint 50 and over (e.g., on top of) the second outer panel 14. The perforated joint 50 may act as a folding seam as well as facilitate the removal of the product return envelope 48 by the consumer.

The second outer panel 14 (and the product return envelope 48) may be folded over the inner panel 30 to cover the consumer products 56, 58, 60 resulting in a second folded position, as shown in FIG. 2C. The product return envelope 48 may be positioned between the inner panel 30 and the second outer panel 14 in the second folded position. The product return envelope 48 may cover and contact the inner panel 30 (e.g., the first top wall 38 and the second top wall 42). Accordingly, the consumer products 58 (the dispenser 60 with cartridge(s) 62) may be secured within the inner panel 30 by the side walls 64 and 66 and the product return envelope 48 folded on top of the inner panel 30. The consumer product 56 (the handle 56) may also facilitate holding the dispenser 60 in place. For example, the dispenser 60 may be positioned between the handle 56 and the side walls 64 and 66. The handle 56 may be held in place by the openings 34 and 36, as well as, the product return envelope 48 folded on top of the inner panel 30. The first outer panel 12 may be folded over the second outer panel 14. The adhesive region 20 may then be pressed against the second outer panel 14, thus resulting in the closed position illustrated in FIG. 1A. The tear tab 26 may be positioned on top of or contact the second outer panel 14; however, the tear tab 26 may not be secured to the second outer panel 14 to facilitate removal of the teat tab 26.

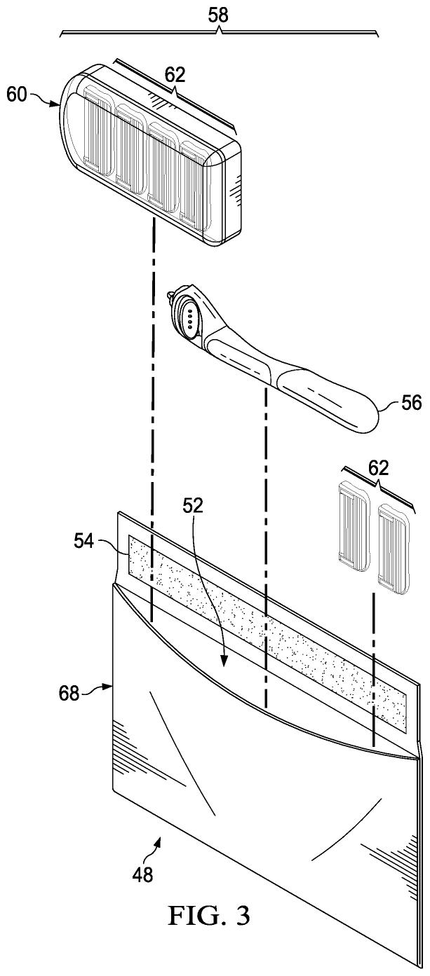

Referring to FIG. 3, a perspective assembly view of the consumer products 56 and 58 and the product return envelope 48 of the consumer product package 10 (FIG. 1A) is illustrated. After a consumer has finished using any one of the consumer products 56 and 58 and wants to recycle them, the consumer may remove the product return envelope 48 from the consumer product package 10 by pulling the product return envelope 48 along the perforated joint 50 (FIG. 1B). The consumer may then place one or more of the consumer products 56 and 58, such as the handle 56 and/or the dispenser 60 with the cartridge 62 inside the pocket 52 of the product return envelope 48. The consumer may also place one or more of the cartridges 62 within the pocket 52. In certain embodiments, the pocket 52 may have a polymer liner to prevent the product return envelope 48 from getting wet and ripping open during handling and shipping. The adhesive strip 54 may then be pressed against a back surface 68 of the product return envelope 48. It is understood the adhesive strip 54 may be include a release strip that is peeled away to reveal an adhesive layer.

Referring to FIG. 4, is a perspective view of the product return envelope 48 of FIG. 3 is illustrated in a closed position. A front surface 70 of the product return envelope 48 may include a recycler address label 72 and a consumer address label 74. It is understood that in certain embodiments, the recycler address label 72 may also be the address of the manufacturer or the shipper of the consumer product package 10 (FIG. 1A) or it may be a company specializing in recycling products. A postage region 76 may be positioned on the front surface 70 of the product return envelope 48. In certain embodiments, the postage region 76 may be a pre-paid postage label (depending on cost) to incentivize the consumer to recycle one of more of the consumer products 56 and 58 (FIG. 2A). It is understood that the postage region 76 may also be printed out separately by the consumer and applied to the product return envelope 48 so the manufacturer does acquire cost if the consumer does not mail the product return envelope 48.

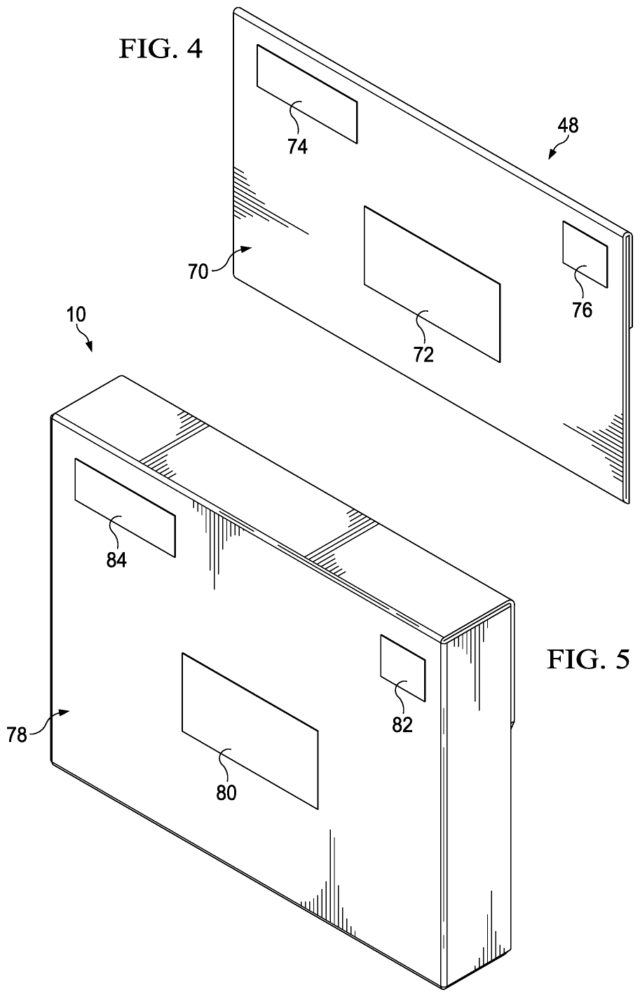

Referring to FIG. 5 a rear perspective view of the consumer product package 10 of FIG. 1A. The consumer product package 10 may have a rear surface 78. The consumer address label 80 may be the same as the consumer address label on the consumer product package 10. However, the consumer address label 80 may be the address the consumer product package 10 is shipped to and the consumer address label 74 on the product return envelope 48 of FIG. 4 may be the return address information. The rear surface 78 may also include a postage region 82 for the cost of shipping the consumer product package 10. A return address region 84 may also be provided on the rear surface 78. In certain embodiments, the return address region 84 may have the same information as the recycler address label 72 of FIG. 4, if the recycler is the same as the manufacturer or shipper of the consumer product package 10.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm ” Furthermore, dimensions should not be held to an impossibly high standard of metaphysical identity that does not allow for discrepancies due to typical manufacturing tolerances. Therefore, the term “about” should be interpreted as being within typical manufacturing tolerances.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A consumer product package comprising:
a first outer panel having a first end with a first adhesive region and a first fold line;
a second outer panel;
an inner panel positioned between the first outer panel and the second outer panel, the inner panel configured to receive a first consumer product;
a product return envelope extending from the second outer panel with a perforated joint between the product return envelope and the second outer panel, the product return envelope defining a pocket;
an adhesive strip between the perforated joint and the pocket; and
a tear tab between the first adhesive region and the first fold line of the first outer panel.

2. The consumer product package of claim 1 wherein the inner panel has a first top wall, a second top wall, a lower inner surface between the first top wall and the second top wall.

3. The consumer product package of claim 2 further comprising a first inner wall extending from the first top wall to the lower inner surface and a second inner wall extending from the second top wall to the lower surface.

4. The consumer product package of claim 3 wherein the one or more products is positioned between the first inner wall and the second inner wall.

5. The consumer product package of claim 3 wherein the at least one of the first inner wall and the first top wall define a first opening.

6. The consumer product package of claim 5 wherein the at least one of the second inner wall and the second top wall define a second opening.

7. The consumer product package of claim 2 wherein the first adhesive region is sealed to the second outer panel in a closed position.

8. The consumer product package of claim 7 wherein the second outer panel is positioned over the inner panel in the closed position.

9. The consumer product package of claim 1 further comprises a consumer product retained by the inner panel.

10. The consumer product package of claim 1 wherein the consumer product comprises a handle or a shaving razor cartridge.

11. A consumer product package comprising:
a first outer panel having a first end with a first adhesive region and a second end;
a second outer panel;
an inner panel positioned between the first outer panel and the second outer panel;
a first consumer product retained by the inner panel;
a product return envelope connected to the second outer panel at a perforated joint, the product return envelope defining a pocket dimensioned to receive the first consumer product;
a second adhesive region between the perforated joint and the pocket; and
a tear tab between the first adhesive region and the second end of the first outer panel, wherein the first adhesive region is sealed to the second outer panel in a closed position.

12. The consumer product package of claim 11 wherein the product return envelope is positioned between the second outer panel and the inner panel in the closed position.

13. The consumer product package of claim 11 wherein the first outer panel, the second outer panel, the product return envelope and the inner panel are formed from a unitary sheet of material.

14. The consumer product package of claim 11 wherein the inner panel defines one or more openings dimensioned to receive the first consumer product.

15. The consumer product package of claim 14 wherein the product return envelope comprises a recycler address label.

16. A method of recycling a consumer product comprising:
providing a consumer product package containing at least one consumer product;
opening the consumer product package by removing a tear tab;
removing a product return envelope having a recycler address label from the consumer product package;
inserting the consumer product into a pocket of the product return envelope;
sealing the product return envelope; and
mailing the product return envelope according to the recycler address label.

17. The method of claim 16 wherein said opening comprises separating a first outer panel of the consumer product package from a second outer panel of the consumer product package by the removing of the tear tab.

18. The method of claim 16 wherein said removing a product return envelope comprises tearing a perforation joint between the product return envelope and a second outer panel of the consumer product package.

19. The method of claim 16 wherein said sealing comprises folding an adhesive region on the product return envelope over a back surface.

20. The method of claim 16 further comprising providing consumer address label on the consumer product package.
